(19) United States
(12) Patent Application Publication
(10) Pub. No.: US 2010/0062260 A1
(43) Pub. Date: Mar. 11, 2010

(54) Composition Containing Porphyrin to Improve Adhesion

(76) Inventors: Tadashi Takano, Irvine, CA (US); Osama M. Musa, Hillsborough, NJ (US)

Correspondence Address: Henkel Corporation, 10 Finderne Avenue, Bridgewater, NJ, 08807, US

(21) Appl. No.: 12/552,331

(22) Filed: Sep. 2, 2009

Related U.S. Application Data
(63) Continuation of application No. PCT/US2007/063970, filed on Mar. 14, 2007.

(51) Int. Cl. B32B 15/092; C08K 5/3415; B32B 15/08; B32B 15/082

(52) U.S. Cl. 428/416; 524/90; 428/457; 428/463

(57) ABSTRACT

An adhesive composition includes a curable resin and a porphyrin derivative, in which the porphyrin derivative has at least one carboxylic acid group that is typically pendant from the porphyrin ring. In another embodiment, this invention is a method for improving adhesion of an adhesive composition to a metal substrate in which a porphyrin derivative is added to a resin, wherein the porphyrin derivative has at least one carboxylic acid group pendant from the porphyrin ring. In a third embodiment, this invention is an assembly in which a semiconductor die is mounted on a metal substrate using an adhesive composition that contains a porphyrin derivative that has at least one carboxylic acid group. In one embodiment the porphyrin derivative is Protoporphyrin IX, having the structure

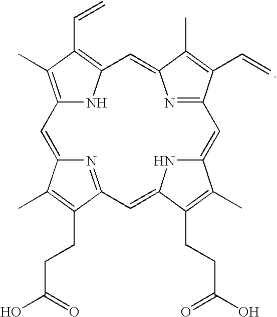

### CROSS-REFERENCE TO RELATED APPLICATION

This application is a continuation of International Patent Application No. PCT/US2007/063970 filed Mar. 14, 2007, the contents of which are incorporated herein by reference.

### FIELD OF THE INVENTION

This invention relates to adhesive compositions, methods for improving adhesion to metal substrates, and assemblies of semiconductor dies joined to metal substrates using adhesive compositions using porphyrin.

### BACKGROUND OF THE INVENTION

Typically, semiconductor dies are attached to metal substrates, such as lead frames, using resin-based adhesives. These adhesives utilize a variety of resin chemistries and serve to hold the die to the metal lead frame during attachment of the semiconductor package to a circuit board, solder reflow, and throughout the use of the package in its end application. As semiconductor packaging technology has evolved, the requirements for the adhesive have similarly changed. In recent years, there has been a growing need for adhesives that can withstand re-flow temperatures up to 270° C. Good adhesion at this high temperature has proven very difficult to attain with existing formulations and there is a need for an adhesive composition that would give improved adhesion to metal surfaces, especially at elevated temperatures. This and other needs are addressed by the various embodiments and configurations of the present invention.

### SUMMARY OF THE INVENTION

In one embodiment this invention is an adhesive composition (hereinafter also referred to as an adhesive) that comprises a curable resin and a porphyrin derivative that has at least one carboxylic acid functional group. In a second embodiment this invention is a method of improving the adhesion of an adhesive composition comprising (i) providing a curable resin and (ii) adding to the resin a porphyrin derivative that has at least one carboxylic acid functional group. In a third embodiment this invention is an assembly comprising a metal substrate, a semiconductor die mounted thereon, and an adhesive composition disposed between the metal substrate and semiconductor die wherein the adhesive composition comprises (i) a curable resin and (ii) a porphyrin derivative that has at least one carboxylic acid functional group.

### DEFINITIONS

The term “alkyl” as used herein refers to a branched or un-branched saturated hydrocarbon group of 1 to 24 carbon atoms, such as methyl (“Me”), ethyl (“Et”), n-propyl, isopropyl, n-butyl, isobutyl, t-butyl, octyl, decyl, and the like.

The term “effective amount” of a compound, product, or composition as used herein is meant a sufficient amount of the compound, product or composition to provide the desired results. As will be pointed out below, the exact amount required will vary from package to package, depending on the particular compound, product or composition used, its mode of administration, and the like. Thus, it is not always possible to specify an exact amount; however, an effective amount may be determined by one of ordinary skill in the art using only routine experimentation.

As used herein, the term “suitable” refers to a moiety that is compatible with the compounds, products, or compositions as provided herein for the stated purpose. Suitability for the stated purpose may be determined by one of ordinary skill in the art using only routine experimentation.

As used herein, “substituted” is used to refer, generally, to a carbon or suitable heteroatom having a hydrogen atom or other atom removed and replaced with a further moiety. Moreover, it is intended that “substituted” refer to substitutions which do not change the basic and novel utility of the underlying compounds, products or compositions of the present invention.

As used herein, the term “B-staging” (and its variants) is used to refer to the processing of a material by heat or irradiation so that if the material is dissolved or dispersed in a solvent, the solvent is evaporated off with or without partial curing of the material, or if the material is neat with no solvent, the material is partially cured to a tacky or more hardened state. If the material is a flow-able adhesive, B-staging will provide extremely low flow without fully curing, such that additional curing may be performed after the adhesive is used to join one article to another. The reduction in flow may be accomplished by evaporation of a solvent, partial advancement or curing of a resin or polymer, or both.

As used herein the term “curing agent” is used to refer to any material or combination of materials that initiate, propagate, or accelerate cure of the composition and includes but is not limited to accelerators, catalysts, initiators, and hardeners.

As used herein, the term “porphyrin” is a heterocyclic macrocycle made from four pyrrole subunits linked on opposite sides (□ position) through four methine bridges (═CH—), and has the following structure:

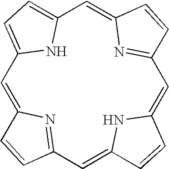

As used herein the terms “porphine”, “porphin”, and “porphyrin” are used interchangeably and have the same meaning, as specified above.

As used herein the terms “free porphyrin”, “free porphin”, and “free porphine” are used to refer to a porphyrin that does not have any metal ions or atoms bound to the nitrogens in the center.

### DETAILED DESCRIPTION OF THE INVENTION

The porphyrin derivative of the present invention is characterized by having at least one carboxylic acid functional group, typically pendant from the porphyrin ring. The presence of both the porphyrin ring and the carboxylic acid functionality gives improved adhesion over porphyrin rings without the carboxylic acid functionality. Carboxylic acid functionality, with its polar nature, is known for improving adhesion in adhesive formulations. Porphyrin rings are used extensively as chelating agents, as they have a propensity for coordinating with metal ions and metal atoms. In the present invention, adhesion strength has been found to improve when and if both the porphyrin ring structure and the carboxylic acid functionalities are present and available for chemical interaction (i.e. they are not bound). The acid functionality and the porphyrin ring work together to give an unexpected, synergistic effect in improving bonding to metal surfaces.

An example of a porphyrin derivative containing at least one carboxylic acid functional group is:

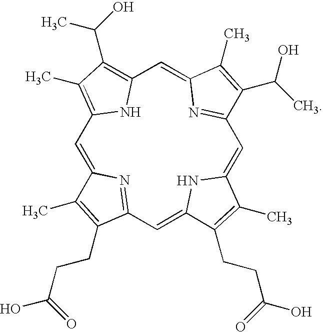

Optionally, the porphyrin derivative may further have at least one reactive double bond pendant from the porphyrin ring. The reactive double bond, combined with the carboxylic acid functionality on the porphyrin ring, provides further enhanced adhesive strength. It is theorized that the double bond participates in the polymerization reaction during cure of the curable resin and that the porphyrin ring becomes part of the polymer matrix. The result is a polymeric structure that has a porphyrin ring with carboxylic acid functionality pendant from the polymer. These two functions, the porphyrin ring and the carboxylic acid, act synergistically to bond the adhesive to the metal. Because the porphyrin and carboxylic acid functionalities are a part of the polymer matrix the adhesion improvement is more pronounced than when those functionalities are simply mixed into the adhesive formulation.

An example of a porphyrin derivative containing at least one reactive double bond in addition to at least one carboxylic acid functional group is:

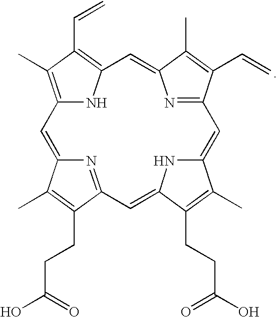

The porphyrin derivative should be a free porphyrin, that is, it should not have any metal ions or atoms bound to the nitrogens in the center to block the nitrogen from bonding to a metal substrate. For the same reasons, a composition containing the porphyrin derivative should not include any free acid molecules, as these can protonate the nitrogens in the porphyrin ring, making the nitrogen unavailable for bonding to the metal substrate. In both these cases, adhesion to the metal would be inhibited.

The porphyrin derivative is present in the adhesive composition in an effective amount. An effective amount will vary depending on the resin system selected, but will typically range between 0.25 and 3.0 wt % of the adhesive formulation, excluding filler content.

The adhesive composition will contain at least one curable resin. Curable resins suitable for use in the present invention include any that polymerize to cure and that provide the desired rheology, modulus, coefficient of thermal expansion, and other properties required for the specific industrial application. The resin(s) may be polymers, oligomers, monomers; pre-polymers, or a combination of these. Suitable resins include thermoplastics, thermosets, elastomers, thermoset rubbers, or a combination of these.

If the composition is to be used as a die attach adhesive election of a suitable resin or resin combination is dependent upon the die type and size, the substrate type, package geometry, and such downstream manufacturing variables as reflow temperatures and reliability required. The adhesive composition may or may not contain solvent, as deemed by the practitioner to be suitable for the particular industrial use. The polymer or curable resin will generally be a major component, excluding any fillers present. Other components, typically used in adhesive compositions, may be added at the option of the practitioner; such other components include, but are not limited to, curing agents, fluxing agents, wetting agents, flow control agents, adhesion promoters (in addition to the porphyrin derivative), and air release agents. The adhesive composition may also contain filler, in which case the filler will be present in an amount up to 95% of the total composition.

Resins and polymers used in the adhesive may be solid, liquid, or a combination of the two. Suitable curable resins include epoxies, acrylates or methacrylates, maleimides, vinyl ethers, polyesters, poly(butadienes), polyimides, benzocyclobutene, siliconized olefins, silicone resins, styrene resins, cyanate ester resins, polyolefins, or siloxanes. The resin will be present in an effective amount, typically between 5 and 100 wt % of the adhesive composition, excluding filler content.

In one embodiment, solid aromatic bismaleimide (BMI) resin powders are included in the adhesive. Suitable solid BMI resins are those having the structure

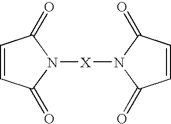

in which X is an aromatic group; exemplary aromatic groups include:

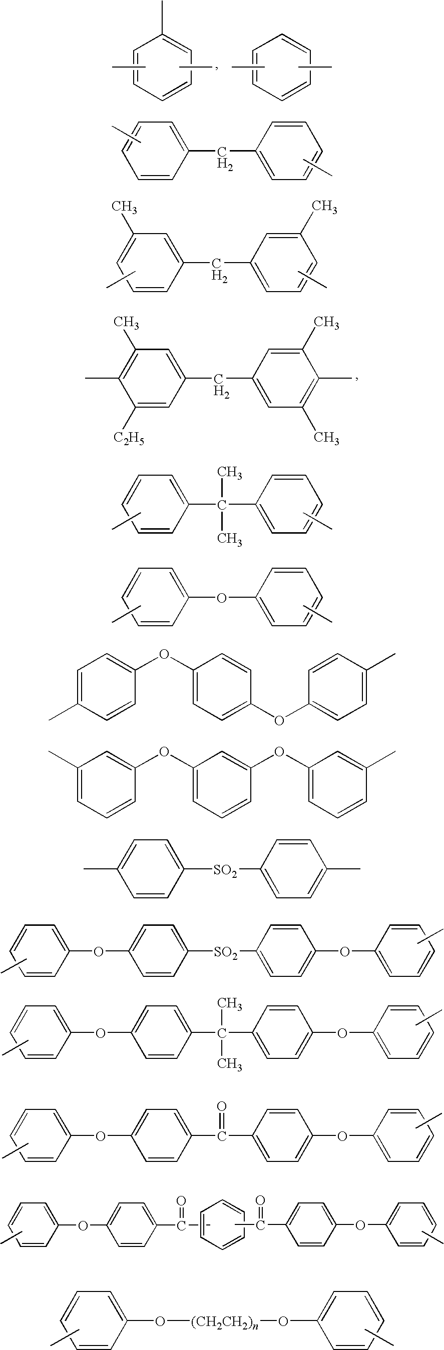

in which n is

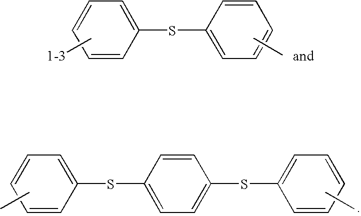

Bismaleimide resins having these X bridging groups are commercially available, and can be obtained, for example, from Sartomer (USA) or HOS-Technic GmbH (Austria).

In another embodiment, maleimide resins for use in the adhesive composition include those having the generic structure

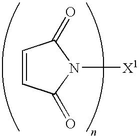

in which n is 1 to 3 and X¹ is an aliphatic or aromatic group. Exemplary X¹ entities include, poly(butadienes), poly(carbonates), poly(urethanes), poly(ethers), poly(esters), simple hydrocarbons, and simple hydrocarbons containing functionalities such as carbonyl, carboxyl, amide, carbamate, urea, or ether. These types of resins are commercially available and can be obtained, for example, from National Starch and Chemical Company and Dainippon Ink and Chemical, Inc.

In one embodiment the maleimide resin of the adhesive composition is 3-maleimidopropionic acid/dimethyloctanol adduct.

In a further embodiment, the maleimide resins are selected from the group consisting of

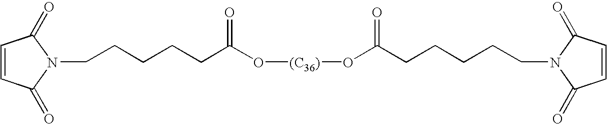

in which C₃₆ represents a linear or branched chain (with or without cyclic moieties) of 36 carbon atoms;

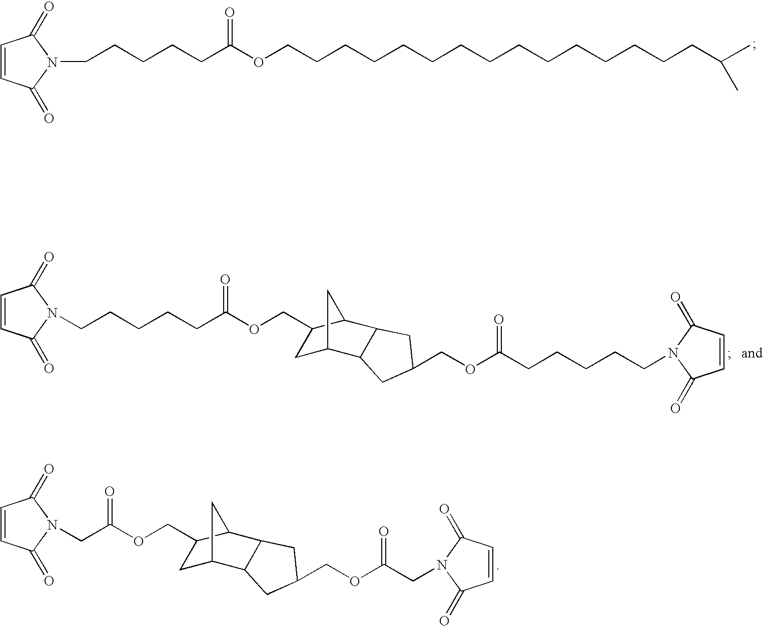

Suitable acrylate resins include those having the generic structure

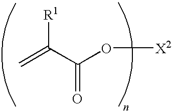

in which n is 1 to 6, R¹ is —H or —CH₃. and X² is an aromatic or aliphatic group. Exemplary X² entities include poly(butadienes), poly(carbonates), poly(urethanes), poly(ethers), poly(esters), simple hydrocarbons, and simple hydrocarbons containing functionalities such as carbonyl, carboxyl, amide, carbamate, urea, or ether. Commercially available materials include butyl(meth)acrylate, isobutyl(meth)acrylate, tricyclodecanedimethanol diacrylate, 2-ethyl hexyl (meth)acrylate, isodecyl(meth)acrylate, n-lauryl(meth)acrylate, alkyl(meth)acrylate, tridecyl (meth)acrylate, n-stearyl(meth)acrylate, cyclohexyl(meth)acrylate, tetrahydrofurfuryl(meth)acrylate, 2-phenoxy ethyl(meth)acrylate, isobornyl(meth)acrylate, 1,4-butanediol di(meth)acrylate, 1.6 hexanediol di(meth)acrylate, 1,9-nonandiol di(meth)acrylate, perfluorooctylethyl(meth)acrylate, 1,10 decandiol di(meth)acrylate, nonylphenol polypropoxylate(meth)acrylate, and polypentoxylate tetrahydrofurfuryl acrylate, available from Kyoeisha Chemical Co., LTD; polybutadiene urethane dimethacrylate (CN302, NTX6513) and polybutadiene dimethacrylate (CN301, NTX6039, PRO6270) available from Sartomer Company, Inc; polycarbonate urethane diacrylate (ArtResin UN9200A) available from Negami Chemical Industries Co., LTD; acrylated aliphatic urethane oligomers (Ebecryl 230, 264, 265, 270, 284, 4830, 4833, 4834, 4835, 4866, 4881, 4883, 8402, 8800-20R, 8803, 8804) available from Radcure Specialities, Inc; polyester acrylate oligomers (Ebecryl 657, 770, 810, 830, 1657, 1810, 1830) available from Radcure Specialities, Inc.; and epoxy acrylate resins (CN104, 111, 112, 115, 116, 117, 118, 119, 120, 124, 136) available from Sartomer Company, Inc. In one embodiment the acrylate resins are selected from the group consisting of isobornyl acrylate, isobornyl methacrylate, lauryl acrylate, lauryl methacrylate, poly(butadiene) with acrylate functionality and poly(butadiene) with methacrylate functionality.

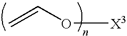

Suitable vinyl ether resins include those having the generic structure in which n is 1 to 6 and X³ is an aromatic or aliphatic group. Exemplary X³ entities include poly(butadienes), poly(carbonates), poly(urethanes), poly(ethers), poly(esters), simple hydrocarbons, and simple hydrocarbons containing functionalities such as carbonyl, carboxyl, amide, carbamate, urea, or ether. Commercially available resins include cyclohenanedimethanol divinylether, dodecylvinylether, cyclohexyl vinylether, 2-ethylhexyl vinylether, dipropyleneglycol divinylether, hexanediol divinylether, octadecylvinylether, and butandiol divinylether available from International Speciality Products (ISP); Vectomer 4010, 4020, 4030, 4040, 4051, 4210, 4220, 4230, 4060, 5015 available from Sigma-Aldrich, Inc.

Suitable poly(butadiene) resins include poly(butadienes), epoxidized poly(butadienes), maleic poly(butadienes), acrylated poly(butadienes), butadiene-styrene copolymers, and butadiene-acrylonitrile copolymers. Commercially available materials include homopolymer butadiene (Ricon130, 131, 134, 142, 150, 152, 153, 154, 156, 157, P30D) available from Sartomer Company, Inc; random copolymer of butadiene and styrene (Ricon 100, 181, 184) available from Sartomer Company Inc.; maleinized poly(butadiene) (Ricon 130MA8, 130MA13, 130MA20, 131MA5, 131MA10, 131MA17, 131MA20, 156MA17) available from Sartomer Company, Inc.; acrylated poly(butadienes) (CN₃O₂, NTX6513, CN301, NTX6039, PRO6270, Ricacryl 3100, Ricacryl 3500) available from Sartomer Inc.; epoxydized poly(butadienes) (Polybd 600, 605) available from Sartomer Company. Inc. and Epolead PB3600 available from Daicel Chemical Industries, Ltd; and acrylonitrile and butadiene copolymers (Hycar CTBN series, ATBN series, VTBN series and ETBN series) available from Hanse Chemical.

Suitable epoxy resins include bisphenol, naphthalene, and aliphatic type epoxies. Commercially available materials include bisphenol type epoxy resins (Epiclon 830LVP, 830CRP, 835LV, 850CRP) available from Dainippon Ink & Chemicals, Inc.; naphthalene type epoxy (Epiclon HP4032) available from Dainippon Ink & Chemicals, Inc.; aliphatic epoxy resins (Araldite CY179, 184, 192, 175, 179) available from Ciba Specialty Chemicals, (Epoxy 1234, 249, 206) available from Union Carbide Corporation, and (EHPE-3150) available from Daicel Chemical Industries, Ltd. Other suitable epoxy resins include cycloaliphatic epoxy resins, bisphenol-A type epoxy resins, bisphenol-F type epoxy resins, epoxy novolac resins, biphenyl type epoxy resins, naphthalene type epoxy resins, dicyclopentadiene-phenol type epoxy resins, reactive epoxy diluents, and mixtures thereof.

Suitable siliconized olefin resins are obtained by the selective hydrosilation reaction of silicone and divinyl materials, having the generic structure,

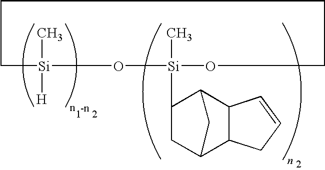

in which n₁ is 2 or more, n₂ is 1 or more and n₁>n₂. These materials are commercially available and can be obtained, for example, from National Starch and Chemical Company.

Suitable silicone resins include reactive silicone resins having the generic structure

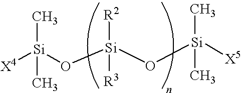

in which n is 0 or any integer, X⁴ and X⁵ are hydrogen, methyl, amine, epoxy, carboxyl, hydroxy, acrylate, methacrylate, mercapto, phenol, or vinyl functional groups, R² and R³ can be H, —CH₃, vinyl, phenyl, or any hydrocarbon structure with more than two carbons. Commercially available materials include KF8012, KF8002, KF8003, KF-1001, X-22-3710, KF6001, X-22-164C, KF2001, X-22-170DX, X-22-173DX, X-22-174DX X-22-176DX, KF-857, KF862, KF8001, X-22-3367, and X-22-3939A available from Shin-Etsu Silicone International Trading (Shanghai) Co., Ltd.

Suitable styrene resins include those resins having the generic structure

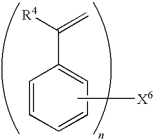

in which n is 1 or greater, R⁴ is —H or —CH₃, and X⁶ is an aliphatic group. Exemplary X⁶ entities include poly(butadienes), poly(carbonates), poly(urethanes), poly(ethers), poly(esters), simple hydrocarbons, and simple hydrocarbons containing functionalities such as carbonyl, carboxyl, amide, carbamate, urea, or ether. These resins are commercially available and can be obtained, for example, from National Starch and Chemical Company or Sigma-Aldrich Co.

Suitable cyanate ester resins include those having the generic structure

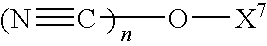

in which n is 1 or larger, and X⁷ is a hydrocarbon group. Exemplary X⁷ entities include bisphenol, phenol or cresol novolac, dicyclopentadiene, polybutadiene, polycarbonate, polyurethane, polyether, or polyester. Commercially available materials include; AroCy L-10, AroCy XU366, AroCy XU371, AroCy XU378, XU71787.02L, and XU 71787.07L, available from Huntsman LLC; Primaset PT30, Primaset PT30 S75, Primaset PT60, Primaset PT60S, Primaset BADCY, Primaset DA230S, Primaset MethylCy, and Primaset LECY, available from Lonza Group Limited; 2-allylphenol cyanate ester, 4-methoxyphenol cyanate ester, 2,2-bis(4-cyanatophenyl)-1,1,1,3,3,3-hexafluoropropane, bisphenol A cyanate ester, diallylbisphenol A cyanate ester, 4-phenylphenol cyanate ester, 1,1,1-tris(4-cyanatophenyl)ethane, 4-cumylphenol cyanate ester, 1,1-bis(4-cyanatophenyl)ethane, 2,2,3,4,4,5,5,6,6,7,7-dodecafluorooctanediol dicyanate ester, and 4,4′-bisphenol cyanate ester, available from Oakwood Products, Inc.

Suitable polymers for the adhesive composition further include polyamide, phenoxy, polybenzoxazine, acrylate, cyanate ester, bismaleimide, polyether sulfone, polyimide, benzoxazine, vinyl ether, siliconized olefin, polyolefin, polybenzoxazole, polyester, polystyrene, polycarbonate, polypropylene, poly(vinyl chloride), polyisobutylene, polyacrylonitrile, poly(methyl methacrylate), poly(vinyl acetate), poly(2-vinylpyridine), cis-1,4-polyisoprene, 3,4-polychloroprene, vinyl copolymer, poly(ethylene oxide), poly(ethylene glycol), polyformaldehyde, polyacetaldehyde, poly(b-propiolacetone), poly(10-decanoate), poly(ethylene terephthalate), polycaprolactam, poly(11-undecanoamide), poly(m-phenylene-terephthalamide), poly(tetramethylene-m-benzenesulfonamide), polyester polyarylate, poly(phenylene oxide), poly(phenylene sulfide), polysulfone, polyimide, polyetheretherketone, polyetherimide, fluorinated polyimide, polyimide siloxane, poly-isoindolo-quinazolinedione, polythioetherimide poly-phenyl-quinoxaline, polyquinixalone, imide-aryl ether phenylquinoxaline copolymer, polyquinoxaline, polybenzimidazole, polybenzoxazole, polynorbornene, poly(arylene ethers), polysilane, parylene, benzocyclobutenes, hydroxy(benzoxazole) copolymer, poly(silarylene siloxanes), and polybenzimidazole.

Other suitable materials for inclusion in adhesive compositions include rubber polymers such as block copolymers of monovinyl aromatic hydrocarbons and conjugated diene, e.g., styrene-butadiene, styrene-butadiene-styrene (SBS), styrene-isoprene-styrene (SIS), styrene-ethylene-butylene-styrene (SEBS), and styrene-ethylene-propylene-styrene (SEPS).

Other suitable materials for inclusion in adhesive compositions include ethylene-vinyl acetate polymers, other ethylene esters and copolymers, e.g., ethylene methacrylate, ethylene n-butyl acrylate and ethylene acrylic acid; polyolefins such as polyethylene and polypropylene; polyvinyl acetate and random copolymers thereof; polyacrylates; polyamides; polyesters; and polyvinyl alcohols and copolymers thereof.

Thermoplastic rubbers suitable for inclusion in the adhesive composition include carboxy terminated butadiene-nitrile (CTBN)/epoxy adduct, acrylate rubber, vinyl-terminated butadiene rubber, and nitrile butadiene rubber (NBR). In one embodiment the CTBN epoxy adduct consists of about 20-80 wt % CTBN and about 20-80 wt % diglycidyl ether bisphenol A: bisphenol A epoxy (DGEBA). A variety of CTBN materials are available from Noveon Inc., and a variety of bisphenol A epoxy materials are available from Dainippon Ink and Chemicals, Inc., and Shell Chemicals. NBR rubbers are commercially available from Zeon Corporation.

Siloxanes suitable for inclusion in the adhesive formulation include elastomeric polymers comprising a backbone and pendant from the backbone at least one siloxane moiety that imparts permeability, and at least one reactive moiety capable of reacting to form a new covalent bond. Examples of suitable siloxanes include elastomeric polymers prepared from: 3-(tris(trimethylsilyloxy)silyl)-propyl methacrylate, n-butyl acrylate, glycidyl methacrylate, acrylonitrile, and cyanoethyl acrylate; 3-(tris(trimethylsilyloxy)silyl)-propyl methacrylate, n-butyl acrylate, glycidyl methacrylate, and acrylonitrile; and 3-(tris(trimethylsilyloxy)silyl)-propyl methacrylate, n-butyl acrylate, glycidyl methacrylate, and cyanoethyl acrylate.

If curing agent is required for the adhesive composition, its selection is dependent on the polymer chemistry used and the processing conditions employed. The curing agent for the resin system will be present in an effective amount, typically up to 60 wt % of the adhesive composition (excluding filler content). As curing agents, the compositions may use aromatic amines, alycyclic amines, aliphatic amines, tertiary phosphines, triazines, metal salts, aromatic hydroxyl compounds, or a combination of these. Examples of such catalysts include imidazoles, such as 2-methylimidazole, 2-undecylimidazole, 2-heptadecyl imidazole, 2-phenylimidazole, 2-ethyl 4-methylimidazole, 1-benzyl-2-methylimidazole, 1-propyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-guanaminoethyl-2-methylimidazole and addition product of an imidazole and trimellitic acid; tertiary amines, such as N,N-dimethyl benzylamine, N,N-dimethylaniline, N,N-dimethyltoluidine, N,N-dimethyl-p-anisidine, p-halogeno-N,N-dimethylaniline, 2-N-ethylanilino ethanol, tri-n-butylamine, pyridine, quinoline, N-methylmorpholine, triethanolamine, triethylenediamine, N,N,N′,N′-tetramethylbutanediamine, N-methylpiperidine; phenols, such as phenol, cresol, xylenol, resorcine, and phloroglucin; organic metal salts, such as lead naphthenate, lead stearate, zinc naphthenate, zinc octolate, tin oleate, dibutyl tin maleate, manganese naphthenate, cobalt naphthenate, and acetyl aceton iron; and inorganic metal salts, such as stannic chloride, zinc chloride and aluminum chloride; peroxides, such as benzoyl peroxide, lauroyl peroxide, octanoyl peroxide, acetyl peroxide, para-chlorobenzoyl peroxide and di-t-butyl diperphthalate; acid anhydrides, such as carboxylic acid anhydride, maleic anhydride, phthalic anhydride, lauric anhydride, pyromellitic anhydride, trimellitic anhydride, hexahydrophthalic anhydride; hexahydropyromellitic anhydride and hexahydrotrimellitic anhydride, azo compounds, such as azoisobutylonitrile, 2,2′-azobispropane, m,m′-azoxystyrene, hydrozones, and mixtures thereof.

In another embodiment, a curing agent is a cure accelerator and may be selected from the group consisting of triphenylphosphine, alkyl-substituted imidazoles, imidazolium salts, onium salts, quaternary phosphonium compounds, onium borates, metal chelates, 1,8-diazacyclo[5.4.0]undex-7-ene or a mixture thereof.

In another embodiment the curing agent can be either a free radical initiator or an ionic initiator, depending on whether a radical or ionic curing resin is chosen. If a free radical initiator is used, it will be present in an effective amount. An effective amount typically is 0.1 to 10 wt %. of the adhesive composition (excluding any filler content). Free-radical initiators include peroxides, such as butyl peroctoates and dicumyl peroxide, and azo compounds, such as 2,2′-azobis(2-methyl-propanenitrile) and 2,2′-azobis(2-methyl-butanenitrile).

If an ionic initiator is used, it will be present in an effective amount. An effective amount typically is 0.1 to 10 wt % of the adhesive composition (excluding any filler content). Suitable ionic curing agents include dicyandiamide, adipic dihydrazide, BF3-amine complexes, amine salts and modified imidazole compounds.

Metal compounds also can be employed as cure accelerators for cyanate ester systems and include, but are not limited to, metal napthenates, metal acetylacetonates (chelates), metal octoates, metal acetates, metal halides, metal imidazole complexes, and metal amine complexes.

Other cure accelerators that may be included in the adhesive formulation include triphenylphosphine, alkyl-substituted imidazoles, imidazolium salts, and onium borates.

In some cases, it may be desirable to use more than one type of cure for the adhesive composition. For example, both ionic and free radical initiation may be desirable, in which case both free radical cure and ionic cure resins can be used in the composition. These compositions would contain effective amounts of initiators for each type of resin. Such a composition would permit, for example, the curing process to be started by ionic initiation using UV irradiation, and in a later processing step, to be completed by free radical initiation upon the application of heat.

One or more fillers may be included in the adhesive composition and may be added to adjust numerous properties including rheology, stress, coefficient of thermal expansion, electrical and/or thermal conductivity, and modulus. The particular type of filler is not critical to the present invention and can be selected by one skilled in the art to suit the needs of the specific end use. Fillers may be conductive or nonconductive. Examples of suitable conductive fillers include carbon black, graphite, gold, silver, copper, platinum, palladium, nickel, aluminum, silicon carbide, boron nitride, diamond, and alumina. Examples of suitable nonconductive fillers include alumina, aluminum hydroxide, silica, vermiculite, mica, wollastonite, calcium carbonate, titania, sand, glass, barium sulfate, zirconium, carbon black, organic fillers, and halogenated ethylene polymers, such as, tetrafluoroethylene, trifluoroethylene, vinylidene fluoride, vinyl fluoride, vinylidene chloride, and vinyl chloride. The filler particles may be of any appropriate size ranging from nano size to several mils. The choice of such size for any particular package configuration is within the expertise of one skilled in the art. Filler may be present in an amount from 0 to 95 wt % of the total adhesive composition.

In one embodiment the adhesive formulation includes spacers, which are particles added for the purpose of controlling the bondline to a predetermined thickness. Selection of appropriate spacers will depend on the package configuration and adhesive formulation and may be made by one skilled in the art without undue experimentation. Suitable spacers include but are not limited to silver, silica, Teflon, polymeric or elastomeric materials. They may range in size from 25 to 150 microns and will be used in an effective amount. An effective amount typically is from 0.1 to 10 wt % of the adhesive composition (excluding filler content).

In another embodiment, a coupling agent, or adhesion promoter, may be added to the adhesive composition. Adhesion promoter selection will depend on the application requirements and resin chemistry employed. Adhesion promoters, if used, will be used in an effective amount: an effective amount is an amount up to 5 wt % of the adhesive composition (excluding filler content). Examples of suitable adhesion promoters include: epoxy-type silane coupling agent, amine-type silane coupling agent, mercapto-type silane coupling agent; Z6040 epoxy silane or Z6020 amine silane available from Dow Corning; A186 Silane, A187 Silane, A174 Silane, or A1289 available from 051 Silquest; Organosilane SI264 available from Degussa; Johoku Chemical CBT-1 Carbobenzotriazole available from Johoku Chemical; functional benzotriazoles; thiazoles; titanates; and zirconates.

In a further embodiment, a surfactant may be added to the adhesive composition. Suitable surfactants include silicones, polyethylene glycol, polyoxyethylene/polyoxypropylene block copolymers, ethylene diamine based polyoxyethylene/polyoxypropylene block copolymers, polyol-based polyoxyalkylenes, fatty alcohol-based polyoxyalkylenes, and fatty alcohol polyoxyalkylene alkyl ethers. Surfactants, if used, will be used in an effective amount: a typical effective amount is an amount up to 5 wt % of the adhesive composition (excluding filler content).

In another embodiment a wetting agent may be included in the adhesive composition. Wetting agent selection will depend on the application requirements and the resin chemistry utilized. Wetting agents, if used, will be used in an effective amount: a typical effective amount is up to 5 wt % (excluding filler content). Examples of suitable wetting agents include Fluorad FC-4430 Fluorosurfactant available from 3M, Clariant Fluowet OTN, BYK W-990, Surfynol 104 Surfactant, Crompton Silwet L-7280, Triton X100 available from Rhom and Haas, Propylene glycol with a preferable Mw greater than 240, Gama-Butyrolactone, castor oil, glycerin or other fatty acids, and silanes.

In a further embodiment, a flow control agent may be included in the adhesive composition. Flow control agent selection will depend on the application requirements and resin chemistry employed. Flow control agents, if used, will be present in an effective amount: an effective amount is an amount up to 20 wt % of the adhesive composition (excluding filler content). Examples of suitable flow control agents include Cab-O—Sil TS720 available from Cabot, Aerosil R202 or R972 available from Degussa, fumed silicas, fumed aluminas, or fumed metal oxides.

In a further embodiment, an air release agent (defoamer) may be added to the adhesive composition. Air release agent selection will depend on the application requirements and resin chemistry employed. Air release agents, if used, will be used in an effective amount. A typical effective amount will be up to 5% wt % of the adhesive composition (excluding filler content). Examples of suitable air release agents include Antifoam 1400 available from Dow Corning, DuPont Modoflow, and BYK A-510.

In some embodiments these compositions are formulated with tackifying resins in order to improve adhesion and introduce tack; examples of tackifying resins include naturally-occurring resins and modified naturally-occurring resins; polyterpene resins; phenolic modified terpene resins; coumarons-indene resins; aliphatic and aromatic petroleum hydrocarbon resins; phthalate esters; hydrogenated hydrocarbons, hydrogenated rosins and hydrogenated rosin esters. Tackifying resins, if used, will be used in an effective amount. A typical effective amount will be up to 5 wt % of the adhesive composition (excluding filler content).

In some embodiments other components may be included in the adhesive composition, for example, diluents such as liquid polybutene or polypropylene; petroleum waxes such as paraffin and microcrystalline waxes, polyethylene greases, hydrogenated animal, fish and vegetable fats, mineral oil and synthetic waxes, naphthenic or paraffinic mineral oils.

Other additives, such as stabilizers, antioxidants, impact modifiers, and colorants, in types and amounts known in the art, may also be added to the adhesive composition.

Common solvents with a proper boiling point ranging from 25° C. to 230° C. may be used in the adhesive composition. Examples of suitable solvents that may be utilized include ketones, esters, alcohols, ethers, and other common solvents that are stable and dissolve the resins in the composition. Suitable solvents include γ-butyrolactone, propylene glycol methyl ethyl acetate (PGMEA), and 4-methyl-2-pentanone.

After the adhesive composition is applied to a substrate, which may include a silicon die, it may be dried and/or B-staged in an optional process step. In one embodiment of the invention the adhesive is hardened to a non-tacky state so that the substrate, silicon wafer, or silicon die may be stored and/or sent to a separate location before the semiconductor die is attached. Typically, the adhesive is hardened sufficiently to enable the adhesive-coated substrates, dies, or wafers, to be stacked on top of one another and stored without the use of interleafs. The hardening of the adhesive may be accomplished in numerous ways, depending on the adhesive formulation employed.

In one embodiment the adhesive composition is thermoplastic and applied at a temperature above its melting point such that it is in a flow-able state. In this case the adhesive composition is hardened by cooling it below its melting point and/or softening point.

In another embodiment the adhesive composition comprises at least a liquid thermoset resin and a solvent. In this embodiment the adhesive is hardened to a non-tacky, or very low-flow, state, by heating the adhesive and substrate sufficiently to evaporate the solvent and partially cure the thermoset resin or resins.

In another embodiment the adhesive contains a solid thermoset resin dissolved in a solvent. After application to the substrate the adhesive will be hardened to a non-tacky, or very low flow, state by heating the adhesive and substrate sufficiently to evaporate the solvent, leaving a non-tacky thermoset resin coating on the substrate.

In another embodiment the adhesive contains at least one liquid thermoset resin. After application to the substrate the adhesive will be hardened to a non-tacky, or very low flow, state by heating the adhesive and substrate sufficiently to partially advance the thermoset resin to a non-tacky, or very low flow, state.

One skilled in the art would appreciate that the adhesive might also contain a combination of resins that could be dried, B-staged, and cured with a combination of mechanisms. For instance, the formulation might be B-staged through the use of ultraviolet radiation and, in a downstream manufacturing step after die attach, cured through the use of heat. The formulation might also contain a combination of resins that have two separate cure temperatures such that the adhesive could be hardened by heating the substrate at the first (and lower) temperature, causing the first resin to cure and the overall adhesive formulation to harden to a non-tacky state. In this case the second resin, which has a second (and higher) curing temperature, would be cured in a subsequent processing step after the die is attached.

If the adhesive does require initial or immediate curing, the cure may be accomplished either as an individual process step, or in conjunction with another processing operation such as solder reflow or wire bonding.

If a B-staging step is utilized, the B-staging temperature will generally be within a range of 80° C. to 200° C., and B-staging will be effected within a time period ranging from one minute to two hours, depending on the particular adhesive formulation chosen. The time and temperature B-staging profile for each adhesive composition will vary, and different compositions can be designed to provide the B-staging profile that will be suited to the particular industrial manufacturing process.

In an alternative embodiment the adhesive is not hardened prior to die attach. In this case the die is mounted onto the substrate while the adhesive is still in a flow-able state. This would enable the formation of a fillet around the die when the die is pressed into the adhesive. The flow of the adhesive and the pressure used to mount the die may be tailored to give the desired amount of fillet for each specific package design. In this embodiment care must be taken to avoid flow of the adhesive into the opening in the substrate, as this would interfere with wire bonding.

The adhesive of the present invention may be used to bond any two articles together and is particularly useful in adhering a semiconductor die to a metal substrate, or to an organic substrate which has exposed metal (such as copper circuits) on its surface. The metal surface may be any suitable for use in the particular industrial use of interest including but not limited to copper, silver, stainless steel, Alloy 42, nickel, any solder, or a pre-plated finish (PPF) such as Ni/Pd/Au, either with or without silver strike on top. The semiconductor die may be any type, size, or shape, as it is not critical to the present invention. The bondline (thickness of adhesive after cure) of the assembly may be any thickness suitable for the specific semiconductor package and typically will range between 10 and 150 □m.

### EXAMPLES

### Example 1

### Effect of Porphyrin Derivative Structure

A variety of porphyrin derivatives were tested in a model adhesive formulation, and compared to a similar formulation that contained no porphyrin derivative, in order to identify the molecular features that would provide improved adhesion. The model formulation is listed in Table 1, below.

TABLE 1

| COMPONENT | PARTS | WT % | WT % |
|---|---|---|---|
| Poly bolybutadiene diacrylate oligomer | 20 | 19.4 | 4.0 |
| Tricyclodecanedimethanol diacrylate | 80 | 77.6 | 15.9 |
| Gamma-methacryloxypropyl-trimethoxy | 1 | 0.97 | 0.2 |
| silane | | | |
| Methyl hydroquinone | 0.1 | 0.097 | 0.02 |
| PORPHYRIN DERIVATIVE | 1 | 0.97 | 0.2 |
| 1,1-Di-tert-amylperoxycyclo-hexane | 1 | 0.97 | 0.2 |
| Silver flake | 400 | 0.00 | 79.5 |

In the case where no porphyrin derivative was tested (Formulation A listed below), the parts of each component were held constant, with the adhesion promoter simply eliminated. Thus, for that formulation, the composition (excluding filler) was as follows: 19.6 wt % oligomer, 78.4 wt % diacrylate, 0.98 wt % silane, 0.098 wt % inhibitor, 0.98 wt % initiator. The composition with filler was as follows: 4.0 wt % oligomer, 15.9 wt % diacrylate, 0.2 wt % silane, 0.02 wt % inhibitor, 0.2 wt % initiator, and 79.7 wt % silver. Each formulation was used to attach 300×300 mil silicon die to a bare copper lead frame, with a bond line thickness of 25 μm. The assemblies were then cured in nitrogen with a 30 minute ramp from room temperature to 175° C. plus a 30 minute hold at 175° C. Following cure the specimens were subjected to thermal processing simulation at 240° C. for one minute plus 175° C. for four hours. Following the thermal simulation, the die shear strength (DSS) was tested at 270° C. on a DAGE 2000 die shear tester. The porphyrin derivatives tested, their functional features, and die shear test results are shown in Table 2 below.

TABLE 2
PORPHYRIN DERIVATIVES TESTED, FUNCTIONAL FEATURES AND DIE SHEAR TEST RESULTS

| | FUNCTIONAL FEATURES OF | | | |
|---|---|---|---|---|
| | PORPHYRIN DERIVATIVE | | | |
| FORMULATION AND PORPHYRIN | Amine | Carboxylic | Reactive | DSS @ 270° C. |
| DERIVATIVE | (porphine) | Acid | double bond | Kg_{f}/die |
| Comparative A | None | None | None | 5.6 |
| None | | | | |
| Inventive B | Yes (x2) | Yes (x2) | Yes (x2) | 27.4 |
| 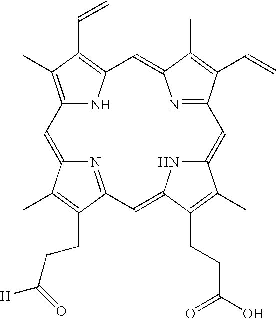 Protoporphyrin IX | | | | |
| Comparative C | Blocked | Yes (x2) | Yes (x2) | 5.1 |
| 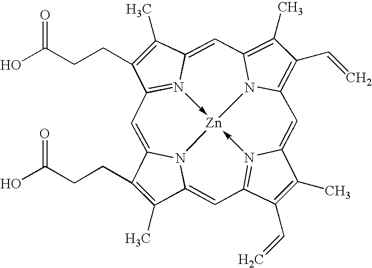 Protoporphyrin IX zinc (II) | | | | |
| Comparative D | Yes (x2) | Blocked | Yes (x2) | 0.8 |
| 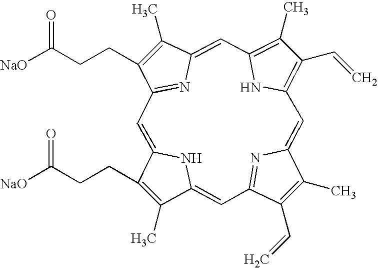 Protoporhyrin IX disodium salt | | | | |
| Inventive E | Yes (x2) | Yes (x2) | No | 16.5 |
| 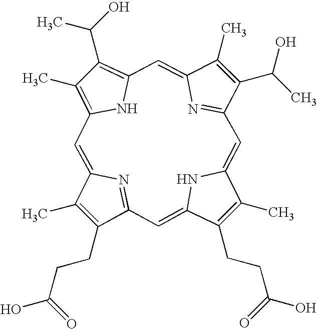 Hematoporphyrin | | | | |
| Comparative F | Yes (x2) | No | No | 4.2 |
| 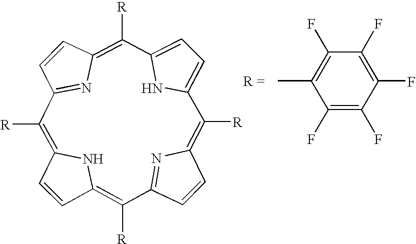 5,10,15,20- Tetrakis(pentafluorophenyl)porphyrin | | | | |
| Comparative G | Yes (x2) | No | No | 2.9 |
| 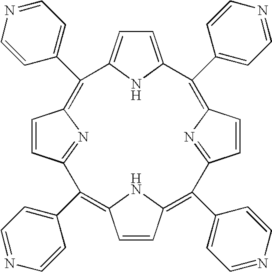 5,10,15,20-Tetra(4-pyridyl) porphyrin | | | | |
| Comparative H | Yes (x2) | No | No | 4.8 |
| 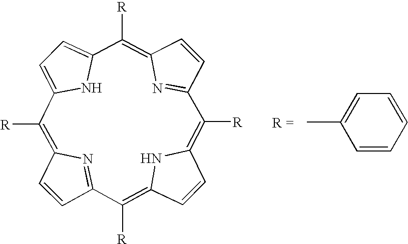 5,10,15,20-Tetraphenyl-21H,23H- porphine | | | | |
| Comparative I | Yes (x2) | No | No | 4.9 |
| 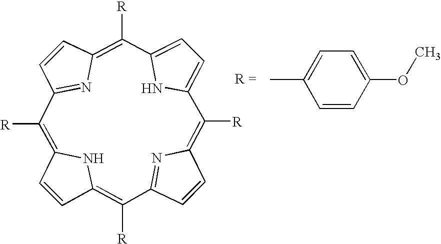 5,10,15,20-Tetrakis(4- methoxyphenyl)-21H,23H-porphine | | | | |
| Comparative J | Blocked | Yes (x4) | No | 1.2 |
| 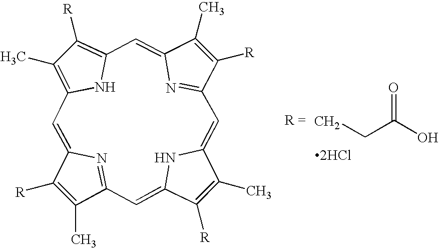 Co-proporphyrin I dihydrochloride | | | | |
| Comparative K | Blocked | Yes (x2) | No | 0.2 |
| 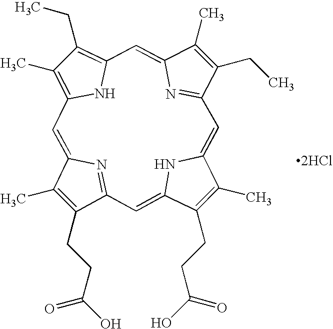 Mesoporphyrin IX dihydrochloride | | | | |
| Comparative L | Blocked | Blocked | Yes (x1) | 3.2 |
| 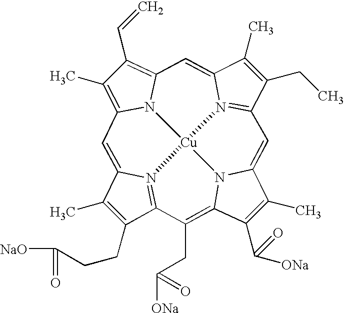 Chlorophyllin sodium copper salt | | | | |
| Comparative M | Blocked | No | No | 3.6 |
| 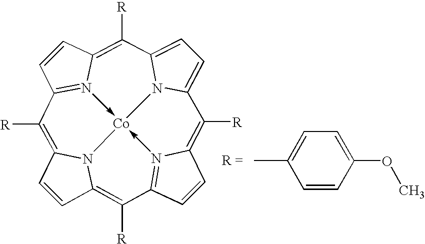 5,10,15,20-Tetrakis(4- methoxyphenyl)-21H,23H-porphine cobalt (II) | | | | |

According to these results the Protoporphyrin IX (Inv B), with its porphine structure, reactive double bonds, and carboxylic acid functionality, provided the best improvement in adhesion compared to the control formulation (Comp A). Hematoporphyrin (Inv E), which had the porphine structure and carboxylic acid functionality, also gave significant adhesion improvement. However, if either the porphine structure or the carboxylic acid functionality were unavailable, as with comparative formulations C, D, and F to M, the die shear strength was at best the same as the control formulation. This illustrates that the porphyrin ring and the carboxylic functionality are acting in a synergistic way to bond strongly to the metal substrate.

The presence of free acid molecules, as with comparative formulations J and K, appears to disturb adhesion to the Cu substrate, yielding lower DSS as compared to the control formulation.

### Example 2

### Effect of Porphyrin Derivative Concentration on Die Shear Strength

Protoporphyrin IX was added to the model formulation cited in Example 1 at various concentrations and the resulting formulations were tested for die shear strength at elevated temperatures to illustrate the effect of porphyrin derivative concentration on the adhesion improvement. The various formulations were used to assemble test specimens for die shear testing using the assembly protocol and cure profile outlined in Example 1. The specimens for each formulation were then divided into four groups and each group was subjected to a different thermal conditioning treatment, as listed in Table 3 below.

TABLE 3
THERMAL CONDITIONING TREATMENTS

| | INITIAL | ADDITIONAL |
|---|---|---|
| REGIMEN | CONDITIONING | CONDITIONING |
| PM | 1 min 240° C. | None |
| | 4 hrs 175° C. | |
| PM5 | 1 min 240° C. | 5 min 270° C. |
| | 4 hrs 175° C. | |
| PPB | 1 min 240° C. | 16 hrs 121° C./ |
| | 4 hrs 175° C. | 100% relative humidity |
| PPB5 | 1 min 240° C. | 16 hrs 121° C./ |
| | 4 hrs 175° C. | 100% relative humidity |
| | | 5 min 270° C. |

Each group of specimens was tested for die shear strength at 270° C. using a DAGE 2000 die shear tester. The concentrations tested and results are summarized in Table 4, below.

TABLE 4
PORPHYRIN DERIVATIVE CONCENTRATION VS. DIE SHEAR
STRENGTH AT 270° C. (KG_{F}/DIE) AFTER VARIOUS
PRECONDITIONING TREATMENTS

| | PROTOPORPHYRIN | | | | |
|---|---|---|---|---|---|
| | IX, WEIGHT PERCENT | DSS, | DSS, | DSS, | DSS, |
| FORMULATION | EXCLUDING FILLER | PM | PM5 | PPB | PPB5 |
| Comparative N | 0 | 4.3 | 4.1 | 0.5 | 1.1 |
| Inventive. O | 0.25 | 36.3 | 38.3 | 7.4 | 11.3 |
| Inventive. P | 0.49 | 37.7 | 40.8 | 4.8 | 11.6 |
| Inventive. Q | 0.98 | 41.2 | 37.0 | 11.4 | 10.8 |
| Inventive. R | 2.0 | 45.1 | 37.9 | 23.3 | 29.4 |
| Inventive. S | 2.9 | 44.0 | 43.4 | 29.9 | 38.5 |

These results show that the adhesion strength improvement may be tailored to meet the requirements of a specific application by varying the amount of porphyrin derivative included in the formulation. It should be noted that the amount of porphyrin derivative required to yield a specific improvement in adhesion will vary, depending on the specific resin system, porphyrin derivative, and metal substrate employed.

### Example 3

### Effect of Resin Chemistry

Protoporphyrin IX was added to formulations using epoxy, acrylate, and maleimide, and their die shear strength was tested. ABLEBOND 84-1LMISR4 is an epoxy-based die attach adhesive commercially available from Ablestik Laboratories. Analogous comparative formulations which contained no porphyrin derivative were also tested to determine whether the porphyrin derivative was effective in improving adhesion for a variety of resin systems. Each formulation was used to build assemblies according to the protocol described in Example 1. The assemblies were also cured, thermally conditioned, and tested for die shear strength at 270° C. according to the protocol described in Example 1. Formulation compositions and DSS at 270° C. are listed in Tables 5-7.

TABLE 5

| | EPOXY-BASED FORMULATIONS | |
|---|---|---|
| | AND DSS AT 270° C. | |
| | Comparative - T | Inventive - U |
| PROTOPORPHYRIN IX, | 0 | 3.0 |
| Weight percent | | |
| ABLEBOND 84-1LMISR4, weight | 100 | 99.26 |
| percent | | |
| DSS at 270° C., Kg_{f}/die | 3.4 | 13.2 |

TABLE 6

| | ACRYLATE BASED FORMULATIONS | | | |
|---|---|---|---|---|
| | AND DSS @ 270° C. | | | |
| | Comparative V | | Inventive W | |
| | Weight % | | Weight % | |
| | No | With | No | With |
| Component | filler | filler | filler | filler |
| Poly butadiene diacrylate | 19.6 | 3.98 | 19.5 | 3.98 |
| oligomer | | | | |
| Tricyclodecanedimethanol | 78.4 | 15.9 | 78.2 | 15.9 |
| diacrylate | | | | |
| Gamma-methacryloxypropyl- | 0.98 | 0.2 | 0.98 | 0.2 |
| trimethoxy silane | | | | |
| Methyl hydroquinone | 0.098 | 0.02 | 0.098 | 0.02 |
| PROTOPORPHYRIN IX | 0 | 0 | 0.24 | 0.05 |
| 1,1-di-tert-amyl- | 0.98 | 0.2 | 0.98 | 0.2 |
| peroxycyclohexane | | | | |
| Silver flake | | 79.7 | | 79.6 |
| DSS at 270° C., kg_{f}/die | | 4.3 | | 36.3 |

TABLE 7

| | MALEIMIDE-BASED FORMULATIONS | | | |
|---|---|---|---|---|
| | AND DSS AT 270° C. | | | |
| | Comparative X | | Inventive Y | |
| | Weight % | | Weight % | |
| | No | With | No | With |
| | filler | filler | filler | filler |
| Ester bismaleimide | 49.0 | 12.4 | 47.6 | 12.3 |
| MPA/dimethyloctanol | 44.1 | 11.2 | 42.8 | 11.1 |
| adduct | | | | |
| N,N-m-phenylene- | 4.9 | 1.2 | 4.8 | 1.2 |
| dimaleimide | | | | |
| Gamma-methacryloxy- | 0.98 | 0.25 | 0.95 | 0.25 |
| propyltrimethoxy silane | | | | |
| Methyl hydroquinone | 0.098 | 0.025 | 0.095 | 0.025 |
| Dicumyl peroxide | 0.98 | 0.25 | 0.95 | 0.25 |
| Protoporphyrin IX | 0 | 0 | 2.9 | 0.74 |
| Silver flake | | 74.6 | | 74.1 |
| DSS at 270° C., Kg_{f}/die | | 1.9 | | 12.6 |

The Protoporphyrin IX was effective in improving the adhesion of the epoxy-based formulation, the acrylate-based formulation, and the maleimide-based formulation,

### Example 4

### Effect of Metal Surface

Inventive Formulation Q and Comparative Formulation N were used to bond silicon die to pre-plated finish (PPF) lead frames, to determine the effectiveness of the inventive formulation on that surface. Each formulation was used to build assemblies according to the protocol described in Example 1. The assemblies were also cured, thermally conditioned, and tested for die shear strength at 270° C. according to the protocol described in Example 1. Results are summarized in Table 8 and show that the presence of Protoporphyrin IX improved adhesion to the PPF lead frame.

TABLE 8
DSS AT 270° C. ON VARIOUS METAL SURFACES

| | Without | With |
|---|---|---|
| | PROTOPORPHYRIN | PROTOPORPHYRIN |
| | IX Comparative N | IX Inventive Q |
| Cu lead frame, Kg/die | 4.3 | 41.2 |
| PPF Lead Frame, Kg_{f}/die | 8.1 | 22.1 |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed:

1. An adhesive composition comprising (i) a curable resin and (ii) a porphyrin derivative that has at least one carboxylic acid functional group.

2. The adhesive composition of claim 1 in which the porphyrin derivative also has at least one double bond pendant from the porphyrin structure.

3. The adhesive composition of claim 1 in which the resin is selected from the group consisting of maleimide, epoxy, or acrylate.

4. The adhesive composition of claim 1 in which the porphyrin derivative is selected from the group consisting of

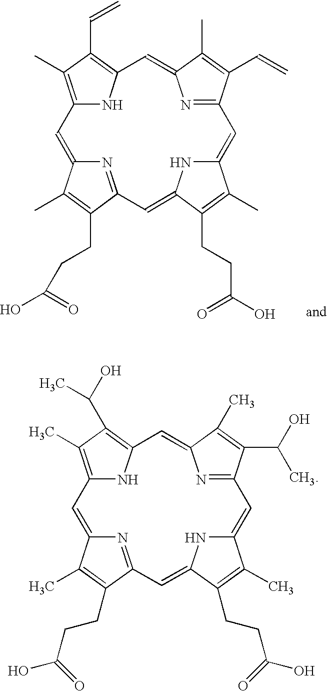

5. The adhesive composition of claim 1 in which the porphyrin derivative is present in an amount of greater than 0.25 wt % of the adhesive composition, excluding any filler present.

6. The adhesive composition of claim 3 in which the porphyrin derivative is present in an amount of greater than 0.25 wt % of the adhesive composition, excluding any filler present.

7. A method of improving the adhesion of an adhesive composition to metal comprising: providing a curable resin, adding to the resin a porphyrin derivative that has at least one carboxylic acid functional group.

8. The method of claim 7 in which the porphyrin derivative also has at least one double bond pendant from the porphyrin structure.

9. The method of claim 7 in which the resin is selected from the group consisting of maleimide, epoxy, or acrylate.

10. The method of claim 7 in which the porphyrin derivative is selected from the group consisting of

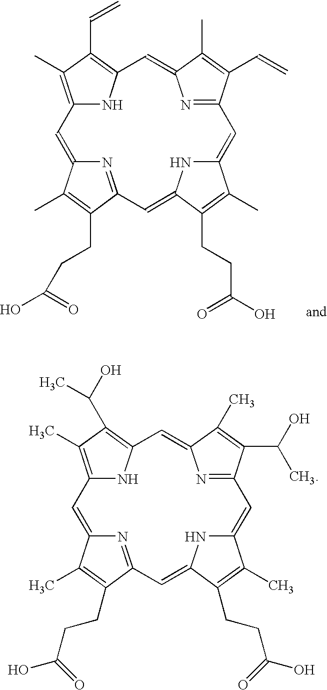

11. The method of claim 9 in which the porphyrin derivative is selected from the group consisting of

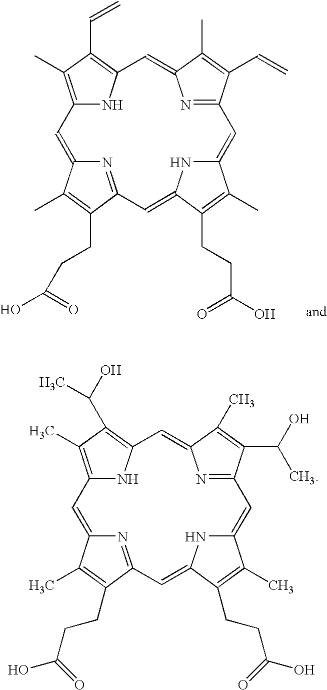

12. An assembly comprising a metal substrate, a semiconductor die mounted thereon, and an adhesive disposed between the metal substrate and semiconductor die wherein the adhesive comprises (i) a curable resin and (ii) a porphyrin derivative that has at least one carboxylic acid functional group.

13. The assembly of claim 12 in which the metal substrate is selected from the group consisting of copper and pre-plated finish.

14. The assembly of claim 12 in which the porphyrin derivative also has at least one double bond pendant from the porphyrin structure.

15. The assembly of claim 12 in which the resin is selected from the group consisting of maleimide, epoxy, or acrylate.

16. The assembly of claim 12 in which the porphyrin derivative is selected from the group consisting of

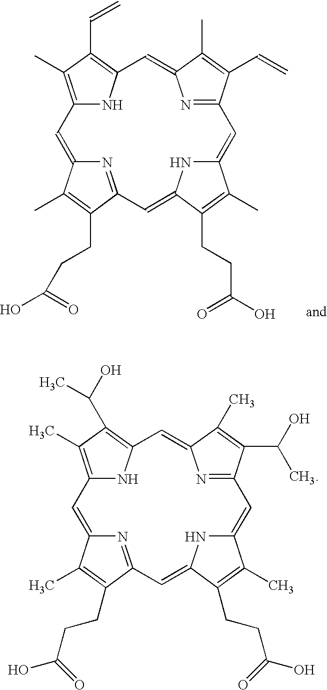

17. The assembly of claim 15 in which the porphyrin derivative is selected from the group consisting of

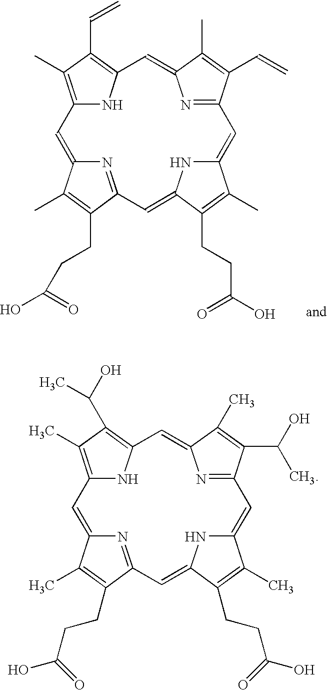

18. The assembly of claim 12 in which the porphyrin derivative is present in an amount of greater than 0.25 wt % of the adhesive composition excluding any filler present.

19. The assembly of claim 15 in which the porphyrin derivative is present in an amount of greater than 0.25 wt % of the adhesive composition excluding any filler present.

20. The adhesive composition of claim 3 in which the porphyrin derivative is selected from the group consisting of [chemical structure]
